(19) United States
(12) Patent Application Publication
(10) Pub. No.: US 2003/0218305 A1
(43) Pub. Date: Nov. 27, 2003

(54) Height adjustable handles for wheelbarrows

(76) Inventor: Kenneth M. Nicolay, Fairway, KS (US)

Correspondence Address: SHUGHART THOMSON & KILROY, PC, 120 WEST 12TH STREET, KANSAS CITY, MO, 64105, US

(21) Appl. No.: 10/152,752

(22) Filed: May 22, 2002

(51) Int. Cl. B62B 1/20

(52) U.S. Cl. 280/47.31; 280/47.315

(57) ABSTRACT

A height adjustable handle arrangement for wheelbarrows includes a pair of rearwardly extending mounting stubs of an upper peripheral frame of a load carrying pan of the wheelbarrow. A multiple sleeve assembly is formed by a plurality of vertical stacked handle receiving sleeves. The sleeve assembly receives a mounting stub in a selected one of the sleeves, and a wheelbarrow handle member is received in another sleeve of the sleeve assembly. Fastener receiving bores in the sleeve assemblies, mounting stubs, and handles are appropriately aligned and receive fasteners such as bolts which are secured by nuts.

### BACKGROUND OF THE INVENTION

The wheelbarrow is a relatively ancient implement or vehicle for moving small to medium loads by human power. A “classic” wheelbarrow includes a V-shaped frame formed by angularly connected side members or shafts terminating in handles at their outer ends. A single wheel is journaled near the vertex of the V-shaped frame, and rear skids extend below the shafts at medial positions to form a platform which supports a load carrying pan, also called a tub, trough, bucket, or hopper. The user stands between the handles, lifts them, and walks toward the barrow, pushing the handles, to move the load. The single wheel facilitates turns. The pan is sometimes deeper at the front end than the rear to proportion more of the weight of the load over the wheel, thereby reducing the effective weight on the handles. Wheelbarrows are particularly useful for moving loads of loose bulk materials and dumping the loads, by tilting the handles up and pivoting the load about the wheel axle.

There have been many variations of wheelbarrows devised throughout the years and many improvements made to correct various shortcomings of wheelbarrows. One particular problem with classic wheelbarrows is the proximity of the handles to the ground. This requires that a user stoop to reach the handles, then lift the handles a considerable distance to move the wheelbarrow and any load therein. Such stooping may result in back injuries, if the handles are not lifted properly. Another problem is that the handles are usually fixed in place, such that tall users are particularly disadvantaged in using such wheelbarrows. In order to overcome these problems, wheelbarrow handles have been repositioned, reshaped, and connected in various ways to improve grasping the handles and carrying them to move the wheelbarrows.

### SUMMARY OF THE INVENTION

The present invention provides an improvement in wheelbarrow structure and, particularly, provides a wheelbarrow handle arrangement which enables the height of the handles to be selectively adjusted. The wheelbarrow of the present invention includes a wheel frame, including horizontal side frame members connected by cross members. One or two wheels are rotatably mounted on the lower side of the wheel frame near a front end. A pair of skids are secured to the lower side of the wheel frame at a rear end. A load carrying pan is secured to and supported by the wheel frame. The pan has a flat bottom wall and angled side and end walls which diverge upwardly. The pan has an upper peripheral frame to stiffen and reinforce the upper edge of the pan.

In general, the adjustable height handle arrangement of the present invention includes transversely spaced sets of handle receiving sleeves positioned in vertically spaced, parallel relation and secured to the wheelbarrow. Elongated handles are releasably received in corresponding sleeves on opposite sides of the wheelbarrow and secured by fasteners, such as bolts and nuts, or the like. More particularly, each set of vertically spaced handle receiving sleeves forms a sleeve assembly. The sleeve assemblies can be permanently attached to the wheelbarrow, permanently attached to the handles or, preferably, releasable from both the wheelbarrow and handles.

In a preferred embodiment, the upper peripheral frame of the wheelbarrow frame has a pair of transversely spaced, rearwardly extending frame members which form mounting stubs, one stub on each side of the wheelbarrow pan. Each stub has a set of fastener receiving bores. Each sleeve assembly is formed as a rectangular box structure with multiple, vertically spaced partitions forming the individual sleeves. Side walls of the sleeves have laterally aligned fastener receiving bores. Each sleeve assembly is secured to the wheelbarrow frame by sliding one of the sleeves over a mounting stub, aligning the bores of the sleeve with those in the stub, and inserting a set of fasteners. Similarly, an end of a handle, with a pair of fastener receiving bores, is inserted into one of the sleeves, the bores aligned, and fasteners inserted to releasably secure the handle in the sleeve. Normally, corresponding sleeves of the opposite sleeve assemblies receive handles to cause the wheelbarrow pan to assume a transversely level orientation when the handles are lifted to move the wheelbarrow. The fasteners can be bolts and nuts or other types of fasteners, as may be appropriate.

The sleeve assemblies are preferably separate from both the handle members and the mounting stubs, for maximum flexibility of height relationships between the handles and the wheelbarrow pan. However, the sleeve assemblies could be more or less permanently secured to either the handle members or the mounting stubs, but not both. If the sleeve assemblies are permanently fastened to the handle members, each of the mounting stubs can be received in one of several sleeves, through a front end of the sleeve. Conversely, if the sleeve assemblies are permanently secured to the mounting stubs, each of the handle members can be received through a rear end of a selected sleeve. The sleeve assemblies can be permanently secured to either the mounting stubs or the handle members by rivets, or the like.

In addition to the use of bores and fasteners for interconnecting the handle members and the sleeve assemblies, other types of connections are contemplated. For example, the sleeves and ends of the handles can be provided with complementary threads to enable threaded connection of the handle members to the sleeve assemblies.

Various objects and advantages of this invention will become apparent from the following description taken in relation to the accompanying drawings wherein are set forth, by way of illustration and example, certain embodiments of this invention. Although not preferred, it is conceivable that the mounting stubs could also be threaded, to enable threaded interconnection of the sleeve assemblies to the mounting stubs.

The drawings constitute a part of this specification, include exemplary embodiments of the present invention, and illustrate various objects and features thereof.

### BRIEF DESCRIPTION OF THE DRAWINGS

FIG. 1 is a side elevational view of a wheelbarrow incorporating an adjustable height handle arrangement which embodies the present invention.

FIG. 2 is a somewhat enlarged fragmentary side elevational view of the wheelbarrow, with a sleeve assembly and handle member shown separated from a mounting stub on the wheelbarrow.

FIG. 3 is a greatly enlarged, fragmentary exploded perspective view illustrating connection details of a sleeve assembly with a mounting stub and handle member.

FIG. 4 is a view similar to FIG. 2 and illustrates a first modified embodiment of the adjustable wheelbarrow handle arrangement of the present invention in which the sleeve assembly is permanently secured to a handle member.

FIG. 5 is a view similar to FIG. 2 and illustrates a second modified embodiment of the adjustable wheelbarrow handle arrangement of the present invention in which the sleeve assembly is permanently secured to a mounting stub on the upper periphery of a wheelbarrow pan.

FIG. 6 is a view similar to FIG. 2 and illustrates a third modified embodiment of the adjustable wheelbarrow handle arrangement of the present invention in which the sleeve assembly and the end of a handle member are provided with complementary threads for interconnection.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 1 generally designates a height adjustable handle arrangement for a wheelbarrow 2 and which embodies the present invention. In general, the arrangement 1 includes a multiple sleeve assembly or connector 3 which adjustably interconnects handle members 4 to a body 5 of the wheelbarrow 2 to enable variation of the height of the handle members 4 relative to the body 5 of the wheelbarrow 2 and a ground surface 6 which supports the wheelbarrow.

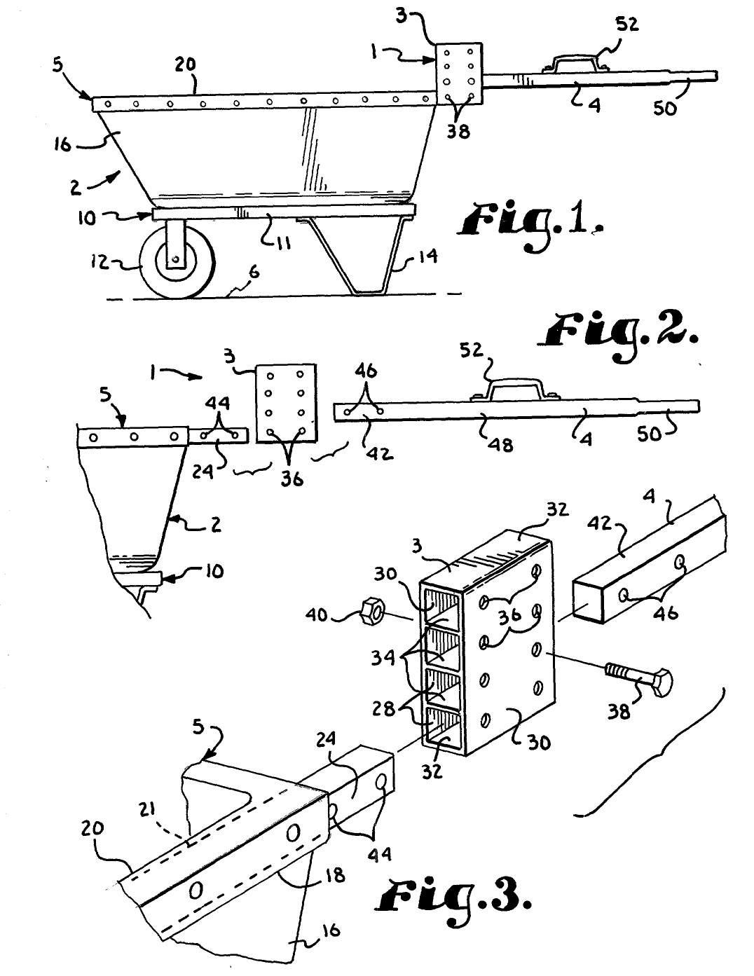

The wheelbarrow body 5 illustrated in FIG. 1 includes a wheel frame 10 formed by horizontally oriented and laterally spaced side members 11 (only one of which is shown) connected by transversely oriented cross members (not shown). The wheel frame 10 has one or two wheels 12 suspended from a front end of the wheel frame 10 and a pair of skids 14 depending therefrom at a rear end. The wheel or wheels 12 facilitate movement of the wheelbarrow 2 when the attached handles 4 are lifted. The skids 14 provide stability when the handles 4 are lowered and resist movement of the wheelbarrow 2 when so lowered.

The wheel frame 10 supports a load carrying pan 16, which may also be referred to as a tub, trough, bucket, or hopper. The illustrated pan 16 has a flat bottom wall and angled side walls which diverge upwardly. Alternatively, other types and shapes of load carrying pans 16 may be incorporated into the wheelbarrow 2. The illustrated pan 16 is provided with an upper peripheral frame or lip 18 to strengthen and stiffen an upper periphery 20 of the pan 16. The peripheral, or upper pan, frame 18 may be simply a particular shaping of the pan material at the periphery 20, such as by being rolled. The peripheral frame 18 may also included embedded structural members 21 as shown in FIG. 3.

The embedded structural members 21 may extend the entire length of the pan 16 from a front end to the rear or they may extend only partially from the rear of the pan to its front end. A pair of rearwardly extending mounting stubs 24 form extensions of the embedded side members 21 of the peripheral frame 18.

Referring to FIGS. 1-3, the adjustable height handle arrangement 1 includes a pair of the multiple sleeve assemblies or connectors 3, each of which is formed by a plurality of tubular sleeves or receivers stacked in vertically spaced parallel relation. The sleeve assembly 3, as best seen in FIG. 3, is formed by side walls 30, top and bottom end walls 32, and intermediate partition walls 34. The side walls 30 have laterally aligned sets of bores or apertures 36 to receive fasteners, such as bolts 38 which are secured by nuts 40. The mounting stubs 24 and mounting ends 42 of the handle members 4 have respective sets of bores 44 and 46 formed therethrough and spaced to align with the sets of bores 36 of the sleeve assemblies 3. The bolts and nuts 38 and 40, or other appropriate fasteners such as fasteners not requiring tools, are used to secure the sleeve assemblies 3 on the mounting stubs 24 and to secure the mounting ends 42 of the handle members 4 within the sleeve assemblies 3. It is to be understood that a single fastener and set of aligned bores 36, 44 and 46 could be utilized to secure or fasten the connector to the mounting stub 24 and the handle member mounting end 42.

The illustrated sleeve assembly 3 may be formed by welding the partition walls 34 within a segment of rectangular cross section tubular stock. Alternatively, other appropriate materials and manufacturing techniques are foreseen, such as casting, extruding, molding or built-up construction, using various metals, polymers, or composites. While the sleeves 28, the mounting stubs 24, and the handle members 4 are illustrated as being of square cross section, other shapes could alternatively be employed. In addition, although the partition walls 34 are preferred to strengthen the sleeve assembly 3, they are not absolutely essential. It is foreseen that a height adjustable handle arrangement 1 could be formed using only the side walls 30 and end walls 32 and the vertically spaced sets of bores 36 to provide for handle height selection. Alternatively, the partition walls 34 could only extend partially across the space between the side walls 30 to generally form guide members, generally defining the different spaces or receivers into which the mounting stubs 24 and handle mounting ends 42 may be inserted for alignment with the vertically spaced sets of bores 36.

Although the mounting ends 42 of the handle members 4 are preferably shaped to match the cross sectional shape of the sleeves 28, such as square, an intermediate section 48 of each handle member 4 may be any shape which is convenient and economical to manufacture. The handles 4 include grip sections 50, formed at a rear or gripping end thereof and which are sized and shaped for comfortable and secure gripping. The handle members 4 may include auxiliary handles 52, which are secured to the intermediate sections 48, to afford a user of the wheelbarrow 2 a better grip in certain ways of manipulating the wheelbarrow 2. For example, the auxiliary handles 52 might provide a convenient grasping place for movements to empty certain types of materials from the pan 16, for a second person to steady or assist in pushing the wheelbarrow 2 with a heavily loaded pan 16, or the like.

In use, the mounting stubs 24 and handles 4 must be fastened within different sleeves 28 of a given sleeve assembly 3. Also, it is preferable for the arrangement 1 on each side of a wheelbarrow 2 to be set up the same. That is, the mounting stubs 24 and handles 4 on opposite sides of the wheelbarrow 2 should be received in corresponding sleeves 28 of the respective sleeve assemblies 3. In the arrangement 1 with the sleeve assembly 3 separate from both the mounting stubs 24 and handles 4, the sleeve assembly 3 and handles 4 can be interconnected to either raise the handles 4 above the level of the mounting stubs 24 or lowered below the level of the mounting stubs, thereby providing a considerable range of height adjustment of the handle members 4. Securing the arrangement 1 in place, once the desired height is determined, requires aligning the bores 36 of the sleeve assemblies 3 with the bores 44 of the mounting stubs 24, aligning the bores 46 of the mounting ends 42 of the handle members 4 with the bores 36, insertion of the bolts 38, and securing the bolts with the nuts 40.

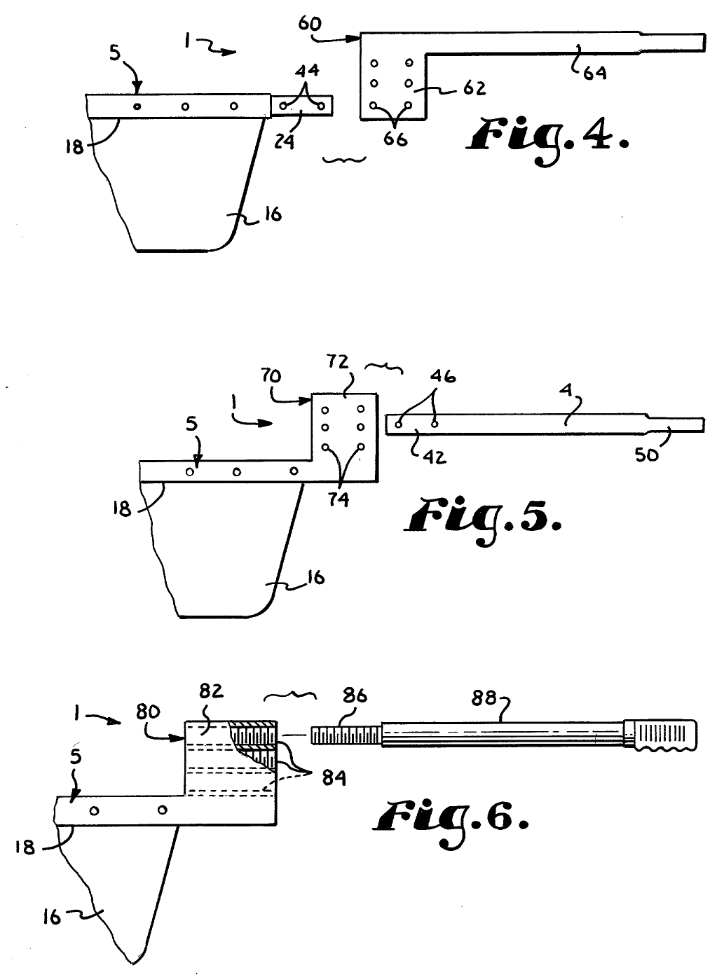

FIG. 4 illustrates a first modified embodiment 60 of the adjustable height handle arrangement 1 in which a multiple sleeve assembly 62 is permanently joined to a modified handle 64. The sleeve assembly 62 is similar to the sleeve assembly 3 in most respects and includes a vertical array of aligned sets of bores 66 for alignment with the bores 44 of a mounting stub 24 of a wheelbarrow body 5 to receive bolts 38 or other fasteners. The handle arrangement 60 can be connected in the manner shown in FIG. 4 to position the handle 64 above the level of the mounting stub 24. Alternatively, the arrangement 60 can be inverted to position the handle 64 below the level of the mounting stub 24.

FIG. 5 illustrates a second modified embodiment 70 of the adjustable height handle arrangement 1 in which a multiple sleeve assembly 72 is permanently secured to a rearwardly extending mounting stub (not shown), similar to the mounting stub 24, or the upper peripheral frame 18 of a wheelbarrow body 5. The sleeve assembly 72 includes a vertical array of aligned sets of bores 74 for alignment with the bores 46 of the mounting end 42 of a handle member 4 to receive fasteners, such as the bolts 38.

FIG. 6 illustrates a third modified embodiment 80 of the adjustable height handle arrangement 1. The illustrated arrangement 80 is similar in to the arrangement 70 in that a multiple sleeve assembly 82 is permanently connected to a rearwardly extending mounting stub (not shown) or upper peripheral frame 18 of a wheelbarrow body 5. However, instead of the bores 74 and 46, the sleeve assembly 82 is formed by several vertically stacked cylindrical sleeves 84 which are internally threaded to receive a threaded cylindrical end 86 of a modified handle member 88. Thus, the handle member 88 is rotated to thread the end 86 into a selected sleeve 84.

As can be appreciated from the description of the preferred embodiments above, the various forms of the handle height adjustment mechanism are particularly well adapted to allow a user to vary the height of the handles and in particular the gripping sections 50 relative to the ground to accommodate the height of the user. It is anticipated that once a particular user sets the handles at a desired height, the user will leave the handles at that height. Therefore fasteners requiring the use of tools, such as bolt 38 and nut 40 should be suitable. However, it is foreseen that quick release fasteners, which do not require tools could also be utilized.

It is believed that the connection of the handles 4 to the upper peripheral frame 18 such as embedded structural members 21 provides greater stability when moving loads with the wheelbarrow, since the load is generally supported below the lifting handles instead of above the handles in most commercially available wheelbarrows. Placing the load above or on top of the handles increases the tendency for the wheelbarrow to tip while it is being pushed. However, it is to be understood that the height adjustable handle arrangement 1 could also be utilized with wheelbarrows in which the pan is supported on top of the handles or for other variations thereof.

It is to be understood that while certain forms of the present invention have been illustrated and described herein, it is not to be limited to the specific forms or arrangement of parts described and shown.

What is claimed and desired to secure by Letters Patent is:

1. A height adjustable handle apparatus for a wheelbarrow and comprising:
(a) a plurality of handle receiving sleeves secured to said wheelbarrow and positioned in vertically spaced, parallel relation; and
(b) an elongated handle member releasably secured in a selected one of said sleeves.

2. An apparatus as set forth in claim 1 and including:
(a) a multiple sleeve assembly formed by said plurality of handle receiving sleeves positioned in said vertically spaced, parallel relation; and
(b) said multiple sleeve assembly being secured to said wheelbarrow.

3. An apparatus as set forth in claim 2 wherein:
(a) said wheelbarrow includes a load carrying pan with an upper periphery; and
(b) said multiple sleeve assembly is secured to said upper periphery of said load carrying pan.

4. An apparatus as set forth in claim 2 wherein:
(a) said wheelbarrow includes a load carrying pan with an upper periphery;
(b) said wheelbarrow includes an upper pan frame member connected to said upper periphery of said load carrying pan; and
(c) said multiple sleeve assembly is secured to said upper frame member.

5. An apparatus as set forth in claim 1 wherein:
(a) said sleeves are non-round in cross section; and
(b) said handle member includes a mounting segment which is non-round in cross section to enable reception in said sleeves.

6. An apparatus as set forth in claim 1 and including:
(a) a pair of sets of said sleeves secured in transversely spaced relation on opposite sides of said wheelbarrow; and
(b) a pair of elongated handle members, each handle member being releasably secured in a corresponding one of said sleeves in a respective set of said sleeves.

7. An apparatus as set forth in claim 1 and including:
(a) an auxiliary handle connected to said elongated handle member to facilitate manipulation of said wheelbarrow.

8. A height adjustable handle apparatus for a wheelbarrow and comprising:
(a) a pair of multiple sleeve assemblies formed by a plurality of handle receiving sleeves positioned in vertically spaced, parallel relation;
(b) said sleeve assemblies being secured to said wheelbarrow in transversely spaced relation; and
(c) a pair of elongated handle members releasably secured in a selected set of corresponding ones of said sleeves.

9. An apparatus as set forth in claim 8 wherein:
(a) said wheelbarrow includes a load carrying pan with an upper periphery; and
(b) each of said multiple sleeve assemblies is secured to said upper periphery of said load carrying pan.

10. An apparatus as set forth in claim 8 wherein:
(a) said wheelbarrow includes a load carrying pan with an upper periphery;
(b) said wheelbarrow includes an upper pan frame member connected to said upper periphery of said load carrying pan; and
(c) each of said multiple sleeve assemblies is secured to said upper frame member.

11. An apparatus as set forth in claim 8 wherein:
(a) said sleeves are non-round in cross section; and
(b) said handle members include mounting segments which are non-round in cross section to enable reception in said sleeves.

12. An apparatus as set forth in claim 8 and including:
(a) an auxiliary handle connected to each of said elongated handle members to facilitate manipulation of said wheelbarrow.

13. A wheelbarrow with a height adjustable handle apparatus and comprising:
(a) a wheelbarrow body;
(b) an elongated wheelbarrow handle member;
(c) an adjustable wheelbarrow handle mounting assembly releasably connecting said handle member to said body, said handle mounting assembly including a plurality of sleeves positioned in vertically spaced, parallel relation; and
(d) said handle being releasably secured in a selected one of said sleeves of said mounting assembly.

14. A wheelbarrow as set forth in claim 13 wherein:
(a) said mounting assembly is permanently secured to said wheelbarrow body; and
(b) said handle member is releasably received in a selected one of said sleeves.

15. A wheelbarrow as set forth in claim 13 wherein:
(a) said mounting assembly is permanently secured to said handle member;
(b) said wheelbarrow body includes a mounting stub; and
(c) said mounting stub is releasably received in a selected on of said sleeves.

16. A wheelbarrow as set forth in claim 13 wherein:
(a) said wheelbarrow body includes a mounting stub;
(b) said mounting stub is releasably received in a selected first one of said sleeves; and
(c) said handle member is releasably received in a selected other one of said sleeves, different from said first one of said sleeves.

17. A wheelbarrow as set forth in claim 13 wherein said handle mounting assembly includes:
(a) a pair of multiple sleeve assemblies formed of said sleeves, said sleeve assemblies being secured to said wheelbarrow body in transversely spaced relation; and
(b) said handle includes a pair of handle members releasably secured respectively in corresponding sleeves of said sleeve assemblies.

18. A wheelbarrow as set forth in claim 17 wherein:
(a) said wheelbarrow body includes a load carrying pan with an upper periphery with a pair of upper pan frame members connected to said upper periphery of said load carrying pan; and
(b) each of said multiple sleeve assemblies is secured to a respective one of said upper pan frame members.

19. A wheelbarrow as set forth in claim 13 and including:
(a) a fastener engaged between said handle and one of said sleeves to releasably secure said handle to said one of said sleeves.

20. A wheelbarrow as set forth in claim 8 and including:
(a) an auxiliary handle connected to said elongated wheelbarrow handle member to facilitate manipulation of said wheelbarrow.

21. A wheelbarrow comprising:
(a) at least one wheel rotatably supported below a tray toward a front end thereof and a pair of frame members connected to said tray on opposite sides thereof and having a stub end extending rearwardly from said tray;
(b) a pair of handle members each having a grip and a mounting end;
(c) a pair of connectors each having a at least three receivers formed therein sized to receive a stub end of one of said frame members and a mounting end of one of said handle members; and
(d) securing means for securing said frame member stub ends and said handle member mounting ends in selected receivers in said connectors.

22. A wheelbarrow comprising:
(a) at least one wheel rotatably supported below a tray toward a front end thereof and a pair of frame members connected to said tray on opposite sides thereof and having a connector formed on each frame member
(b) a pair of handle members each having a grip and a mounting end;
(c) a connector formed on a rearward extending end of each frame member and having at least two receivers formed therein sized to receive a mounting end of one of said handle members; and
(d) means for securing said handle member mounting ends in a selected receiver in said connectors.

23. A wheelbarrow comprising:
(a) at least one wheel rotatably supported below a tray toward a front end thereof and a pair of frame members connected to said tray on opposite sides thereof and having a stub end extending rearwardly from said tray;
(b) a pair of handle members each having a grip and a mounting end having a connector formed thereon, each connector having a at least two receivers formed therein sized to receive a stub end of one of said frame members; and
(c) means for securing said frame member stub ends in selected receivers in said connectors.
